(19) United States
(12) Patent Application Publication
(10) Pub. No.: US 2020/0331184 A1
(43) Pub. Date: Oct. 22, 2020

(54) METHOD AND DEVICE FOR PRODUCING A CYLINDRICAL BODY

(71) Applicant: ARNO FRIEDRICHS HARTMETALL GMBH & CO. KG, Mainleus (DE)

(72) Inventor: Arno Friedrichs, Mainleus (DE)

(21) Appl. No.: 16/648,741

(22) PCT Filed: Jun. 8, 2018
(86) PCT No.: PCT/EP2018/065186

§ 371 Date: Jul. 13, 2020

(30) Foreign Application Priority Data
Sep. 21, 2017 (DE) 10 2017 121 940.4

(51) Int. Cl. B29C 48/25; B29C 48/09; B29C 48/11; B29C 48/00; B29C 48/355; B29C 48/92

(52) U.S. Cl. CPC B29C 48/266; B29C 48/09; B29C 48/11; B29L 2023/00; B29C 48/355; B29C 48/92; B29C 48/0022

(57) ABSTRACT

The invention relates to a method and a device for producing a circular-cylindrical body (4) which consists of a plastic compound and which has at least one helical inner recess that runs in the interior of the body. The method has the following steps: producing a circular-cylindrical body (4), which consists of a plastic compound and which has at least one linear inner recess that runs in the interior of the body, by means of an extrusion molding die (1), discharging the circular-cylindrical body (4) out of the extrusion molding die (1) via a twisting section (7) onto a holding and transporting device (2) which is designed to hold and transport the circular-cylindrical body (4) and which can be rotated about the longitudinal axis of the holding and transporting device, twisting the circular-cylindrical body (4) on the twisting section (7) in order to form the at least one helical inner recess by rotating the holding and transporting device (2) together with the circular-cylindrical body being held and transported in the holding and transporting device, and discharging the circular-cylindrical body (4), which has at least one helical inner recess running in the interior of the body, out of the holding and transporting device (2) onto a storage device (3).

The invention relates to a method and to a device for producing a circular-cylindrical body made of plastics mass.

EP 1 230 046 B1 discloses a method and a device for producing a substantially circular-cylindrical body made of plastics mass, in particular of a sintered metal blank, which comprises at least one helical internal recess that extends inside the body. The body is firstly produced, for example extruded, in which the internal recess is substantially linear. The body, which is cut to a specific length, is then subjected to a rolling movement while being supported, over its entire length, on a support having a friction surface arrangement, the speed of which movement linearly and continuously changes across the length of the body, as a result of which the body is uniformly twisted.

EP 2 313 218 B1 discloses another method and another device for producing a circular-cylindrical body made of plastics mass, which comprises at least one helical internal recess that extends inside the body. In this case, too, the body is firstly produced having a linear profile of the internal recess. The body, which is cut to a specific length, is then subjected to a rolling process by means of a friction surface arrangement, which is likewise adjacent to said body over its entire length, having a friction surface that is arranged in parallel with the support. This rolling process takes place in several steps, in which, in a first step, a rolling movement is carried out using a first axis of rotation of the friction surface arrangement, and in a second step, a rolling movement is carried out using a second axis of rotation of the friction surface arrangement that is different from the first axis of rotation, the axes of rotation extending perpendicularly to the support or friction surface.

The object of the invention consists of specifying a method and a device for producing a circular-cylindrical body made of plastics mass, which has one or more helical internal recesses, in which the production of the helical internal recesses is simplified.

This object is achieved by a method having the features indicated in claim 1 and by a device having the features indicated in claim 9. Advantageous embodiments and developments of the invention are stated in the dependent claims.

In the method according to the invention for producing a circular-cylindrical body made of plastics mass, which comprises at least on helical internal recess that extends thereinside, the following steps are carried out:
Producing, by means of an extrusion die, a circular-cylindrical body made of plastics mass, which comprises at least one linear internal recess that extends thereinside,
discharging the circular-cylindrical body from the extrusion die by means of a twisting portion and passing it to a retaining and conveying device that is designed to retain and convey the circular-cylindrical body and can rotate about its longitudinal axis,
twisting the circular-cylindrical body on the twisting portion in order to form the at least one helical internal recess by rotating the retaining and conveying device together with the circular-cylindrical body that is retained and conveyed therein, and
discharging the circular-cylindrical body, which comprises at least one helical internal recess that extends thereinside, from the retaining and conveying device and passing it to a deposition device.

According to one embodiment of the invention, the retaining and conveying device that can rotate about its longitudinal axis is actuated by two motors, one of which is a feed motor that controls the speed at which the circular-cylindrical body is fed in the rotary retaining and conveying device, and the other is a torque motor, which simultaneously controls the rotational speed of the retaining and conveying device, which can rotate about its longitudinal axis, in order to feed the circular-cylindrical body in the longitudinal direction.

According to one embodiment of the invention, the circular-cylindrical body is held inside the retaining and conveying device and moved in the direction of its longitudinal direction by conveyor belts.

According to one embodiment of the invention, the conveyor belts are mounted on idler pulleys, the running speed of which is set by the feed motor in order to move the circular-cylindrical body.

According to one embodiment of the invention, the circular-cylindrical body is held and moved in the direction of its longitudinal axis inside the retaining and conveying device by two, three or four conveyor belts, which are moved at a uniform running speed.

According to one embodiment of the invention, the feed speed and the rotational speed of the retaining and conveying device is set by a control unit, which supplies control signals to the feed motor and the torque motor.

According to one embodiment of the invention, the speed at which the circular-cylindrical body is pressed out of the extrusion die is measured by means of a speed sensor and is set in the control unit as the target feed speed.

The speed of the conveyor belts and the rotational speed of the retaining and conveying device are continuously adapted to the pressing-out speed measured by the speed sensor and/or the bar diameter of the plastics circular-cylindrical body leaving the extrusion die in order to satisfy the desired pitch specifications in each case.

According to one embodiment of the invention, the circular-cylindrical body is cut to a preset length by means of a cutting device, the cutting procedure taking place between the extrusion die and the rotary retaining and conveying device or between the rotary retaining and conveying device and the deposition device.

A device according to the invention for producing a circular-cylindrical body made of plastics mass, which comprises at least one helical recess that extends thereinside, comprises
an extrusion die that is designed for producing a circular-cylindrical body made of plastics mass, which body comprises at least one linear internal recess that extends thereinside,
a retaining and conveying device that is designed to retain and convey the circular-cylindrical body that is output by the extrusion die and can rotate about its longitudinal axis, and
a deposition device, which is designed to receive the circular-cylindrical body, which is discharged from the retaining and conveying device and comprises at least one helical internal recess that extends thereinside.

According to one embodiment of the invention, the device also comprises a feed motor, which is designed to control the feed speed of the circular-cylindrical body in the rotary retaining and conveying device, and a torque motor, which is designed to control the rotary speed of the retaining and conveying device that can rotate about its longitudinal axis.

According to one embodiment of the invention, the retaining and conveying device comprises conveyor belts, which are designed to retain and move the circular-cylindrical body in its longitudinal direction.

According to one embodiment of the invention, the conveyor belts are mounted on idler pulleys, the running speed of which can be set by means of the feed motor.

According to one embodiment of the invention, the device comprises two, three or four conveyor belts distributed in the circumferential direction of the circular-cylindrical body, which are preferably equidistantly distributed.

According to one embodiment of the invention, the device comprises a control unit, which is designed to supply control signals to the feed motor and to the torque motor in order to set the feed speed and the rotational speed.

One embodiment of the invention consists in that the device comprises a cutting device for cutting the circular-cylindrical body, which device is arranged between the extrusion die and the retaining and conveying device or between the rotary retaining and conveying device and the deposition device.

The advantages of the invention consist in particular in that the process of twisting the circular-cylindrical body made of plastics mass only requires a very small amount of space. It can be carried out on the twisting portion provided between the extrusion die and the retaining and conveying device, wherein only a very small amount of space is required between the extrusion die and the retaining and conveying device in order to provide this twisting portion. Furthermore, by changing the rotational speed of the retaining and conveying device during the twisting process, the invention makes it possible to produce circular-cylindrical bodies, in which the pitch angle of the helical internal recesses extending in the interior of the circular-cylindrical bodies changes. This is advantageous in that, by means of the method according to the invention, blanks for hard metal drills can be produced, for example, in which comparatively densely packed cooling channels are located in the cutting region, and therefore the cutting edge can be optimally designed and the removal of chips can be improved as a result of larger pitch distances over the course of the tool chip space.

Additional advantages of the invention consist in that the device according to the invention can have minimum space requirements.

Additional advantageous features of the invention can be found in the example depiction thereof by means of the figures, in which:

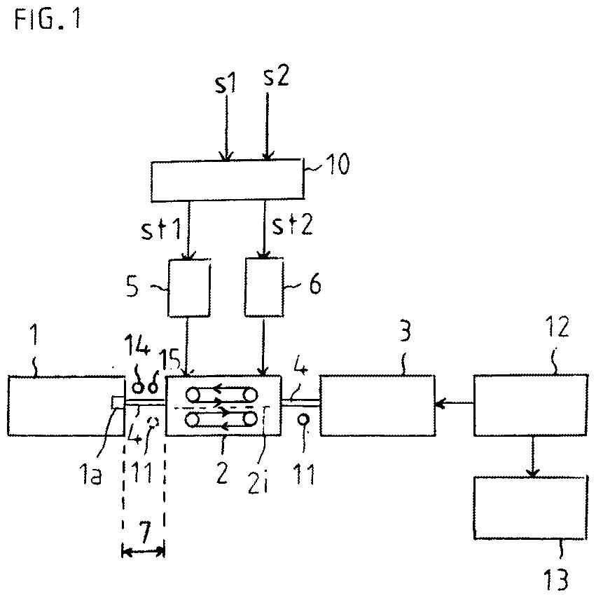

FIG. 1 is a block diagram of a device for producing a circular-cylindrical body made of plastics mass, which comprises one or more helical internal recesses in the interior thereof, by using a twisting process,

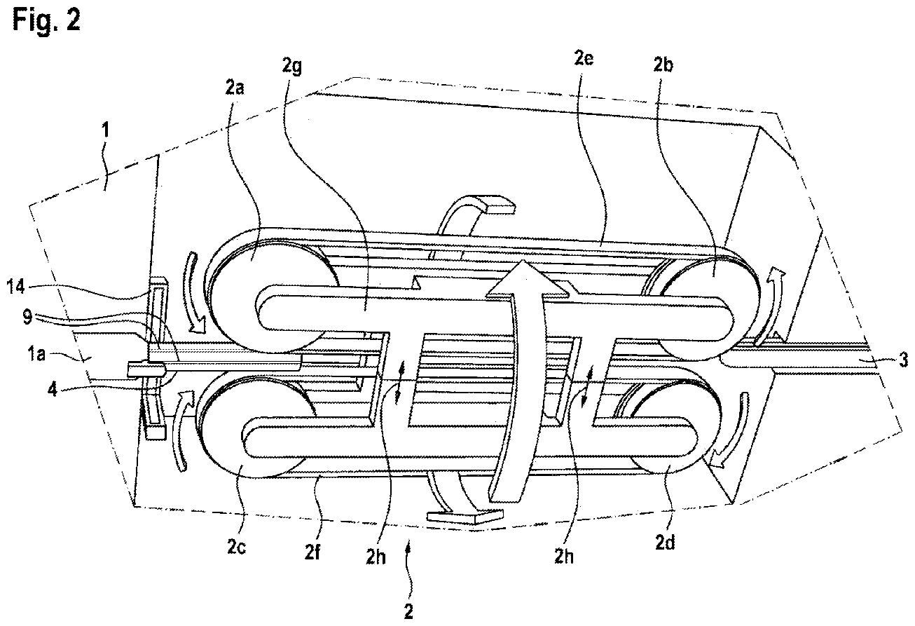

FIG. 2 is a first perspective view depicting the twisting process,

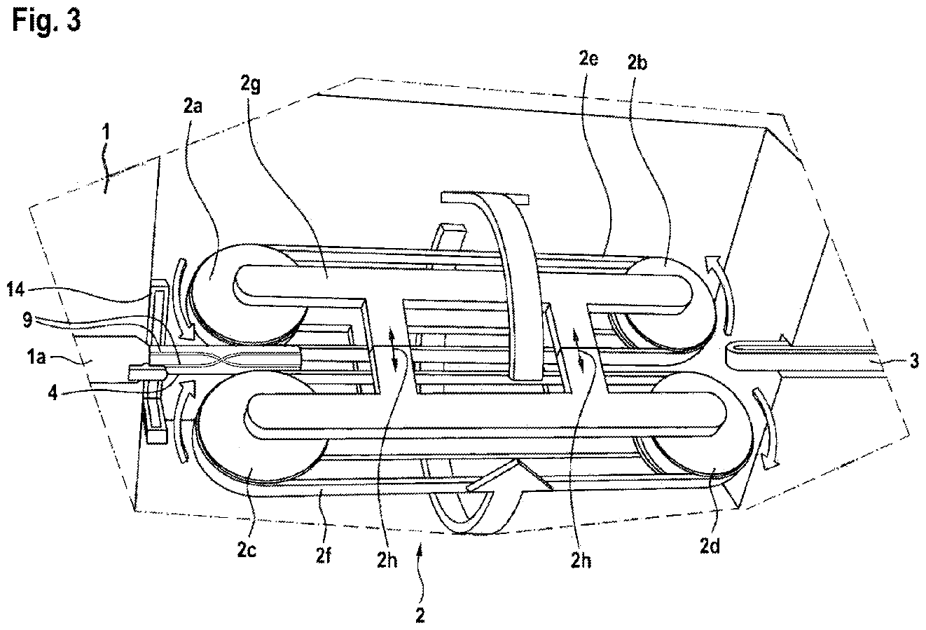

FIG. 3 is a second perspective view depicting the twisting process,

FIG. 4 is a third view depicting the twisting process,

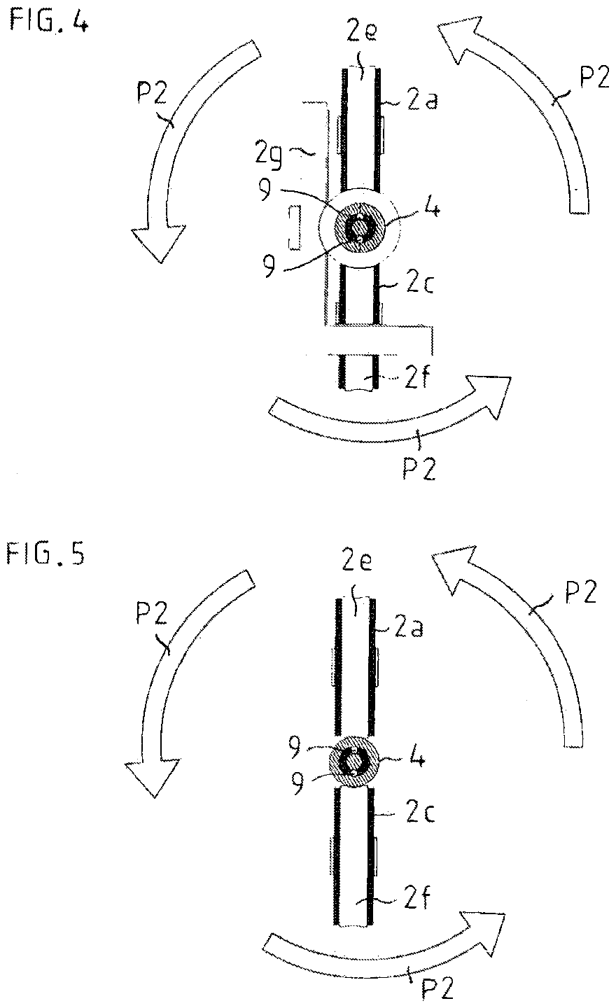

FIG. 5 is a fourth view depicting the twisting process,

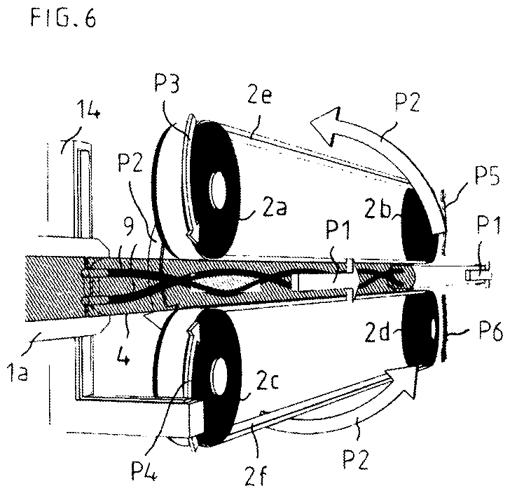

FIG. 6 is a fifth perspective view depicting the twisting process, and

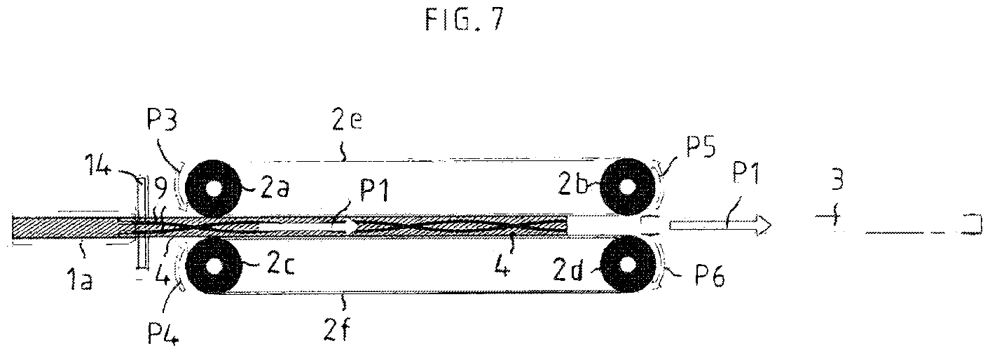

FIG. 7 is a sixth view depicting the twisting process.

FIG. 1 shows a block diagram of a device for producing a circular-cylindrical body made of plastics mass, which comprises one or more helical internal recesses in the interior thereof. This circular-cylindrical body made of plastics mass is in particular a sintered metal blank, which consists for example of a hard metal powder comprising a binder or adhesive that is kneaded therein. This sintered metal blank has a comparatively soft consistency, and therefore has to be handled, for example conveyed, very carefully in order to prevent irreversibly deforming the blank.

Sintered metal blanks are required in particular for producing drilling tools or milling cutters or drilling tool inserts made of hard metal, steel or ceramic materials, By means of the helical profile of the at least one internal recess, which is used to pass coolant or lubricant into the cutting region in the finished drilling tool, the drilling tool can be provided with helical flutes on its outer surface, which is often advantageous for providing advantageous cutting and machining properties, and is therefore intended.

The production of such tool blanks is dependent on the fact that the pitch angle of the at least one helical internal recess is kept within boundaries having very close tolerances over the entire length of the blank. Amongst other things, this is necessary because flutes are usually cut in the tool blank after the sintering process. These flutes are cut by means of largely automatic machines, and therefore, if the helical internal recesses are inaccurately produced, the reject rate can be high.

The device shown in FIG. 1 makes it possible to keep the pitch angle of the at least one helical internal recess within boundaries having very close tolerances over the entire length of the blank. The device shown comprises an extrusion die 1, which discharges a circular-cylindrical body 4 made of plastics mass at its outlet via a nozzle 1a, which body comprises one or more linearly extending internal recesses in its interior.

This circular-cylindrical body 4 discharged from the extrusion die 1 is guided to a retaining and conveying device 2 by means of a twisting portion 7, which extends from the outlet of the extrusion die 1 up to the inlet of said retaining and conveying device 2.

Here, it is retained and further conveyed—as is yet to be explained below on the basis of the other figures. As the circular-cylindrical body 4 is further conveyed, the retaining and conveying device 2 rotates about its central longitudinal axis 2i. On account of this rotational movement of the retaining and conveying device 2 about its central longitudinal axis together with the simultaneous further conveyance of the circular-cylindrical body 4 inside the retaining and conveying device 2, the circular-cylindrical body 4 is twisted on the twisting portion 7, i.e. in the region between the extrusion die 1 and the retaining and conveying device 2.

This further conveyance and twisting is continued until the circular-cylindrical body 4 has reached the outlet of the retaining and conveying device 2. Here, after being cut to the desired length, it is discharged in the shape of a circular-cylindrical body, which comprises one or more helical internal recesses in its interior, and is supplied to a deposition device 3.

In order to remove the circular-cylindrical body having at least one circular-cylindrical internal recess in its interior from the deposition device 3, a removal robot 12 is used, which removes the circular-cylindrical body 4 from the deposition device 3 and supplies it to a storage device 13. Here, the circular-cylindrical body can be temporarily stored or further processed, for example sintered.

Said cutting of the circular-cylindrical body to the respectively desired length is carried out using a cutting device 11, which is arranged either in the region of the twisting portion 7 between the extrusion die 1 and the retaining and conveying device 2 or in the region between the retaining and conveying device 2 and the deposition device 3.

Furthermore, the device shown in FIG. 1 comprises a speed sensor 14, which is arranged between the outlet of the extrusion die 1 and the retaining and conveying device 2 and the pressing-out speed of the circular-cylindrical body 4 leaving the extrusion die 1 is measured. Furthermore, the device shown in FIG. 1 comprises a diameter sensor 15, which is likewise arranged between the outlet of the extrusion die 1 and the retaining and conveying device 2 and measures the diameter of the circular-cylindrical body 4 leaving the extrusion die.

The sensor signals s1 and s2 derived from these sensors are supplied to a control unit 10. This unit is designed to make the sensor signals supplied thereto consistent with a preset target pitch value, which results from the conveying speed and the rotational speed of the retaining and conveying device.

In this case, the conveying speed is preset by the pressing-out speed determined by the speed sensor. The rotational speed w of the retaining and conveying device is determined using the following relationship:

ω=360°/tst;

tst =lst/vp

lst=d·π/tan(sw)

In this case:

Ω is the rotational speed,

tst is the pitch time,

lst is the pitch length,

vp is the pressing-out speed,

d is the diameter of the body pressed out of the extrusion die

sw is the pitch angle, and

tan(sw) is the tangent of the pitch angle.

In this case, the pitch length 1st is to be understood to mean the length of a period of the pitch along the central axis of the cylindrical body. The pitch angle is the angle between the central axis of the cylindrical body and the pitch profile. The pitch time is the time required for pressing a pitch length.

Furthermore, FIG. 1 shows a torque motor 6, to which with control signals st2 are supplied by the control unit 10. This torque motor 6 causes the rotation of the rotary retaining and conveying device 2 at a rotary speed that is preset by the control unit 10. By actuating the torque motor 6 in a different manner, the rotary speed of the rotary retaining and conveying device 2 can be increased or decreased as necessary.

For example, this can be carried out for the purpose of increasing or decreasing the pitch angle of the internal recesses extending inside the circular-cylindrical body across the length of the circular-cylindrical body in order to produce a circular-cylindrical body made of plastics mass that comprises helically extending internal recesses, the pitch angle of which changes across the length of the circular-cylindrical body.

Furthermore, a rotational speed sensor (not shown in FIG. 1) can also be provided, which measures the rotational speed of the retaining and conveying device 2. The rotational speed sensor signal derived from this rotational speed sensor is supplied to the control unit 10. Said control unit is designed to compare the rotational speed measured signal supplied thereto with a preset target rotational speed signal. If the rotational speed measured differs from the target rotational speed, the control unit 10 provides control signals st2 to the torque motor 6 such that the torque motor 6 adapts or regulates the speed of the rotational movement of the retaining and conveying device 2. This also increases the accuracy and therefore the quality of the helically extending internal recesses, which are produced by means of the method according to the invention and extend in the interior of a circular-cylindrical body.

FIG. 2 is a first perspective view depicting the twisting process of the circular-cylindrical body 4 discharged from the extrusion die 1. This circular-cylindrical body discharged from the nozzle 1a of the extrusion die 2 is guided over the twisting portion 7, which extends from the outlet of the nozzle 1a of the extrusion die 1 up to the inlet of the retaining and conveying device 2, is held in the retaining and conveying device 2 by the conveyor belts 2e and 2f thereof that are guided on idler pulleys 2a and 2c and is retained between these conveyor belts. Due to the rotational movement of the idler pulleys 2a and 2c, which is shown by arrows, the circular-cylindrical body 4 is conveyed further in the forward direction. At the same time as this forward movement of the circular-cylindrical body 4 inside the retaining and conveying device, the retaining and conveying device 2 rotates about its central longitudinal axis 2i (not shown in FIG. 2). This rotational movement is shown in FIG. 2 by the arrows pointing in the circumferential direction of the retaining and conveying device 2.

As a result of the described forward movement of the circular-cylindrical body 4 inside the retaining and conveying device at the same time as the rotation of the retaining and conveying device 2, the circular-cylindrical body 4 is twisted on the twisting portion 7, as is yet to be explained below on the basis of FIG. 3.

The retaining and conveying device 2 shown in FIG. 2 further comprises an additional idler pulley 2b, the above-mentioned conveyor belt 2e being placed around the idler pulleys 2a and 2b.

Furthermore, the retaining and conveying device 2 shown in FIG. 2 comprises an additional idler pulley 2d,the above-mentioned conveyor belt 2f being placed around the idler pulleys 2c and 2d. The idler pulleys 2a , 2b, 2c and 2d are mounted on a truck 2g that is used as an idler pulley bearing.

The circular-cylindrical body 4, which is retained between the two conveyor belts 2e and 2f and is further conveyed in the forward direction is discharged at the outlet of the retaining and conveying device 2 and passed to the deposition device 3.

Furthermore, the truck 2g of the retaining and conveying device 2 comprises distance adjustment means 2h, by means of which the distance between the conveyor rollers 2a and 2c and the distance between the conveyor rollers 2b and 2d can be adjusted. This is advantageous in that the retaining and conveying device 2 can also be used together with other extrusion dies, which provide circular-cylindrical body having a larger or even smaller diameter.

FIG. 3 is a second perspective view depicting the twisting process of the circular-cylindrical body 4 discharged from the extrusion die 1. In particular, it is clear from FIG. 3 that the circular-cylindrical body 4 held between the two conveyor belts 2e and 2f have been moved forwards in comparison with the rotation of the retaining and conveying device 2 that has already been carried out in FIG. 2, and that the circular-cylindrical body 4 has already been twisted on the twisting portion 7, and therefore the internal recesses 9 provided in the interior of the circular-cylindrical body are also twisted.

This twisting process is continued by an additional forwards movement of the circular-cylindrical body inside the retaining and conveying device 2 together with the simultaneous additional rotational movement of the retaining and conveying device about its central longitudinal axis until the circular-cylindrical body is lastly discharged from the retaining and conveying device 2 and discharged to the deposition device 3.

In order to remove the circular-cylindrical body made of plastics mass from the deposition device 3, a removal robot 12 is provided, which removes the circular-cylindrical body from the deposition device 3 and supplies it to a storage device 13, in which the circular-cylindrical body 4 can also be further processed, for example sintered.

FIG. 4 is a third simplified representation depicting the twisting process. This representation shows the truck 2g of the retaining and conveying device 2, the idler pulleys 2a and 2c fastened to this truck, the conveyor belts 2e and 2f that are placed around these idler pulleys and are moved thereby and the circular-cylindrical body 4, which is held by the conveyor belts and is conveyed forwards, together with its internal recesses 9. Furthermore, arrows P2 are shown, which depict the rotational movement of the components shown in FIG. 4 about the central longitudinal axis of the retaining and conveying device, which extends into the drawing plane.

FIG. 5 is a fourth further simplified representation depicting the twisting process that does not contain the components of the retaining and conveying device. This representation shows the idler pulleys 2a and 2c, the conveyor belts 2e and 2f that are placed around these idler pulleys and are moved thereby and the circular-cylindrical body 4, which is held by the conveyor belts and is conveyed forwards, together with its internal recesses 9. Furthermore, arrows P2 are shown, which depict the rotational movement of the components shown in FIG. 5 about the central longitudinal axis of the retaining and conveying device, which extends into in the drawing plane.

FIG. 6 is a fifth perspective view depicting the twisting process. This representation shows the nozzle 1a of the extrusion die, the speed sensor 14, the circular-cylindrical body 4 together with its internal recesses 9, the idler pulleys 2a and 2b and the conveyor belt 2e that is placed around said idler pulleys and is conveyed thereon, the idler pulleys 2c and 2d and the conveyor belt 2f that is wrapped around said idler pulleys and is conveyed thereon, Furthermore, arrows P2 are shown, which depict the rotational movement of the components belonging to the retaining and conveying device along with the circular-cylindrical body 4 held therein and conveyed therein about the central longitudinal axis of the retaining and conveying device 2. Furthermore, arrows P1 are shown, which depict the direction of the forward movement of the circular-cylindrical body 4 held in the retaining and conveying device. Furthermore, FIG. 6 shows an arrow P3, which shows the direction of rotation of the idler pulley 2a, an arrow P4, which shows the direction of rotation of the idler pulley 2c, an arrow P5, which shows the direction of rotation of the idler pulley 2b and an arrow P6, which shows the direction of rotation of the idler pulley 2d. Furthermore, FIG. 6 shows the circular-cylindrical body 4 in a position in which, unlike in the FIGS. 2 and 3, it has already been conveyed further inside the retaining and conveying device. It is clear that, in this position in which said body has already been conveyed further, the internal recesses in the circular-cylindrical body have already been twisted several times in the shape of a pitch.

FIG. 7 is a sixth view depicting the twisting process. This representation also shows the nozzle 1a of the extrusion die, the speed sensor 14, the circular-cylindrical body 4 together with its internal recesses 9, the idler pulleys 2a and 2b and the conveyor belt 2e that is placed around said idler pulleys and is conveyed thereon, the idler pulleys 2c and 2d and the conveyor belt 2f that is placed around said idler pulleys and is conveyed thereon. Furthermore, arrows P1 are shown, which depict the direction of the forward movement of the circular-cylindrical body 4 held in the retaining and conveying device. Furth more, FIG. 6 shows an arrow P3, which shows the direction of rotation of the idler pulley 2a, an arrow P4, which shows the direction of rotation of the idler pulley 2c, an arrow P5, which shows the direction of rotation of the idler pulley 2b and an arrow P6, which shows the direction of rotation of the idler pulley 2d. Furthermore, FIG. 7 shows the circular-cylindrical body 4 in a position in which, unlike in FIGS. 2 and 3, it has already been conveyed further inside the retaining and conveying device. It is clear that, in this position in which said body has already been conveyed further, the internal recesses in the circular-cylindrical body have already been twisted several times in the shape of a pitch. Furthermore, FIG. 7 shows the deposition device 3 that is positioned behind the retaining and conveying device.

### LIST OF REFERENCE SIGNS

1 extrusion die

1a nozzle

2 retaining and conveying device

2a idler pulley

2b idler pulley

2c idler pulley

2d idler pulley

2e conveyor belt

2f conveyor belt

2g truck, idler pulley bearing

2h distance adjustment means

2i central longitudinal axis of the retaining and conveying device

3 deposition device

4 circular-cylindrical body

5 feed motor

6 torque motor

7 twisting portion

9 internal recess

10 control unit

11 cutting device

12 removal robot

13 storage device

14 speed sensor

15 diameter sensor

P1, . . . , P6 directional arrow

s1 speed sensor signal

s2 diameter sensor signal

st1 control signal

st2 control signal

1. A method for producing a circular-cylindrical body made of plastics mass, which comprises at least one helical internal recess that extends thereinside, comprising the following steps:
Producing, by means of an extrusion die (1), a circular-cylindrical body (4) made of plastics mass, which comprises at least one linear internal recess that extends thereinside,
discharging the circular-cylindrical body (4) from the extrusion die (1) by means of a twisting portion (7) and passing it to a retaining and conveying device (2) that is designed to retain and convey the circular-cylindrical body (4) and can rotate about its longitudinal axis (2i),
twisting the circular-cylindrical body (4) on the twisting portion (7) in order to form the at least one helical internal recess (9) by rotating the retaining and conveying device (2) together with the circular-cylindrical body (4) that is retained and conveyed therein, and
discharging the circular-cylindrical body (4), which comprises at least one helical internal recess (9) that extends thereinside, from the retaining and conveying device (2) and passing it to a deposition device (3).

2. The method as per claim 1, characterized in that the retaining and conveying device (2) that can rotate about its longitudinal axis is actuated by two motors, one of which is a feed motor (5) that controls the speed at which the circular-cylindrical body is fed in the rotary retaining and conveying device, and the other is a torque motor (6), which simultaneously controls the rotational speed of the retaining and conveying device (2), which can rotate about its longitudinal axis, in order to feed the circular-cylindrical body in the longitudinal direction.

3. The method as per either claim 1 or claim 2, characterized in that the circular-cylindrical body (4) is held inside the retaining and conveying device (2) and moved in the direction of its longitudinal axis by conveyor belts (2e, 2f).

4. The method as per any one of the preceding claims, characterized in that the conveyor belts (2e, 2f) are mounted on idler pulleys (2a, 2b, 2c, 2d), the running speed of which is set by the feed motor (5) in order to move the circular-cylindrical body (4).

5. The method as per either claim 3 or claim 4, characterized in that the circular-cylindrical body (4) is held and moved in the direction of its longitudinal axis inside the retaining and conveying device (2) by two, three or four conveyor belts, which are moved at a uniform speed.

6. The method as per any one of the preceding claims, characterized in that the feed speed and the rotational speed of the retaining and conveying device (2) is set by a control unit (10), which supplies control signals (st1, st2) to the feed motor (5) and the torque motor (6).

7. The method as per any one of the preceding claims, characterized in that the speed at which the circular-cylindrical body (4) is pressed out of the extrusion die (1) is measured by means of a speed sensor (14) and/or in that the diameter of the circular-cylindrical body that is discharged from the extrusion die is measured by means of a diameter sensor (15).

8. The method as per any one of the preceding claims, characterized in that the circular-cylindrical body (4) is cut to a preset length by means of a cutting device (11), the cutting procedure taking place between the extrusion die (1) and the rotary retaining and conveying device (2) or between the rotary retaining and conveying device (2) and the deposition device (3).

9. A device for producing a circular-cylindrical body made of plastics mass, which comprises at least one helical recess that extends thereinside, comprising
an extrusion die (1) that is designed for producing a circular-cylindrical body (4) made of plastics mass, which body comprises art least one linear internal recess that extends thereinside,
a retaining and conveying device (2) that is designed to retain and convey the circular-cylindrical body (4) and can rotate about its longitudinal axis, and
a deposition device (3), which is designed to receive the circular-cylindrical body, which is discharged from the retaining and conveying device (2) and comprises at least one helical internal recess (9) that extends thereinside.

10. The device as per claim 9, further comprising:
a feed motor (5), which is designed to control the feed speed of the circular-cylindrical body (4) in the rotary retaining and conveying device (2), and
a torque motor (6), which is designed to control the rotary speed of the retaining and conveying device (2) that can rotate about its longitudinal axis.

11. The device as per either claim 9 or claim 10, characterized in that the retaining and conveying device (2) comprises conveyor belts (2e, 2f), which are designed to retain and move the circular-cylindrical body (4) in its longitudinal direction.

12. The device as per claim 11, characterized in that the conveyor belts (2e, 2f) are mounted on idler pulleys (2a, 2b, 2c, 2d), the running speed of which can be set by means of the feed motor (5).

13. The device as per either claim 11 or claim 12, characterized in that said device comprises two, three or four conveyor belts (2e, 2f) that are preferably equidistantly distributed in the circumferential direction of the circular-cylindrical body (4).

14. The device as per any one of claims 10 to 13, characterized in that said device comprises a control unit (10), which is designed to supply control signals (st1, st2) to the feed motor (5) and to the torque motor (6) in order to set the feed speed and the rotational speed.

15. The device as per any one of claims 9 to 14, characterized in that said device comprises a cutting device (11) for cutting the circular-cylindrical body (4), which device is arranged between the extrusion die (1) and the retaining and conveying device (2) or between the rotary retaining and conveying device (2) and the deposition device (3).
